(19) United States
(12) Patent Application Publication
(10) Pub. No.: US 2005/0181176 A1
(43) Pub. Date: Aug. 18, 2005

(54) Profiled system

(76) Inventor: Joachim Hessemer, Hof/Saale (DE)

Correspondence Address: DEWITT ROGGIN PLLC, 12 E. LAKE DRIVE, ANNAPOLIS, MD, 21403, US

(21) Appl. No.: 10/507,675

(22) PCT Filed: Mar. 14, 2003
(86) PCT No.: PCT/DE03/00836

(30) Foreign Application Priority Data
Mar. 14, 2002 (DE) 102 12 341.1

(51) Int. Cl. B32B 3/28

(52) U.S. Cl. 428/163

(57) ABSTRACT

An arrangement of at least two profile sections (2, 3, 8, 9) connected with one another by means of an insulating chamber (1, 13), whereby at least the surface of the side of at least one profile section (3, 9) that is turned away from the insulating chamber (1, 13), compared to the surface of a side that is turned toward the insulating chamber (1, 13) is enlarged in order to render a facilitated thermal transfer between the surroundings and the side of the profile section (3, 9) that is turned away from the insulating chamber (1, 13) possible.

The invention relates, in general, to an arrangement of at least two profile sections or profiles, which are connected with one another by way of an insulating chamber, for example, or are embodied in the structural manner of a post or a bar.

Generally, arrangements of profiles are known, which are used, for example, in facades, window frames, doorframes or skylight rows. The arrangement encompasses, in most cases, two profile sections that are connected with one another by means of an insulating, air, or damping chamber and suitable connecting crosspieces and/or seals made of plastic or rubber. In the process, at least one profile section abuts an inner zone having one temperature, and at least one profile section abuts an outer zone, or profile sections having a different temperature that are coupled to the outer zone.

In the case of the known profile arrangements, it is fundamentally disadvantageous that even in the case of a thermal separation of the profile sections, condensation or sweating occurs on the profile section that abuts the inner zone, and as a result, for example, the danger of mold formation is increased.

It is therefore the task of the present invention to construct an extension of the arrangement of profile sections in such a manner that a formation of condensation on at least one of the profile sections/profiles is prevented or diminished.

This task is resolved by the characteristics of the independent patent claim 1, such that extensions to good purpose are described by the characteristics of the dependent claims.

In particular, an arrangement having at least two profile sections that are connected with one another by an insulating chamber underlies the concept according to the invention, such that the surface of the side of at least one profile section that is turned away from the insulating chamber is enlarged compared to the surface of the side that is turned toward the insulating chamber in order to render a facilitated thermal transfer possible between the surroundings and the side of the profile section that is turned away from the insulating chamber. The concept profile section, used herein, can indicate both a portion of a profile, a hollow profile, for example, as well as an entire profile. What is essential, ultimately, is the fact that due to an enlargement of at least one surface of one side, the [missing text] is available for a thermal exchange between the surroundings, which abut the profile section with the enlarged surface and the profile section, and a better thermal penetration of the profile section or the profile occurs. The temperature of the profile section with the enlarged surface thus approximates, by these means, the temperature of the surroundings that abut the profile section, so that the temperature difference that is responsible for forming the condensation is reduced, or in the ideal case, avoided. In order to improve upon the effect according to the invention, the possibility exists, in addition, of producing the profile section that is turned toward the inner zone from a material having a high degree of thermal conductivity, and of producing the profile section that is turned toward the outer zone, by contrast, of a material having a low degree of thermal conductivity.

In a preferred embodiment, the enlarged surface of the side that is turned away from the insulating chamber is embodied in the form of ribs. A rib-shaped or corrugated geometry can be produced in a simple manner using a casting process for example, or an extrusion process, though other surface geometries are conceivable as well. In particular, pyramidal or pin-shaped surface geometries can be realized in a manner that is similarly simple. Beyond that, the possibility exists of increasing the surface of the side that is turned away from the insulating chamber by increasing the roughness of the surface.

In a preferred embodiment, substantially the entire front surface is embodied in the form of ribs, such that the embodiment preferably assumes the form of cooling ribs or heating ribs. The effect according to the invention is enhanced by the enlargement of the surface, so that the utilization of the entire front surface, that is, for example, the provision of “cooling ribs” across the entire extent of the front surface, for the purpose of increasing the surface, is particularly advantageous.

Furthermore, it is advantageous if the profile sections themselves embody at least one hollow profile. The use of hollow profile sections renders a reduction of material use, and thus, of material costs, possible. Beyond that, the use of hollow profile sections guarantees, in an advantageous method and manner, a usability of the arrangement that is as simple as possible, since the entire arrangement, when hollow profile sections are used, exhibits a lower total weight.

Furthermore, it is advantageous if at least two connecting crosspieces are provided, which connect the profile sections with one another and constitute, with the sides of the profile sections that are oriented toward the insulating chamber, the insulating chamber. Due to the simultaneous use of the connecting crosspieces to fix the profile sections to one another and to demarcate the insulating chamber, the result is a surprisingly simple and effective structure of the complete arrangement with a minimum number of structural parts.

Furthermore, it is advantageous if the connecting crosspieces are made of plastic and the profile sections are made of aluminum. Due to the use of a plastic for the connecting crosspieces, the insulating chamber's insulating effect is additionally enhanced, since plastics, as a rule, exhibit low thermal conductivity.

Additional characteristics and advantages of the invention become clearer in the course of reading the following description, which is cited merely by way of example, and not in any restrictive fashion, which is given with reference to the enclosed drawings. In them:

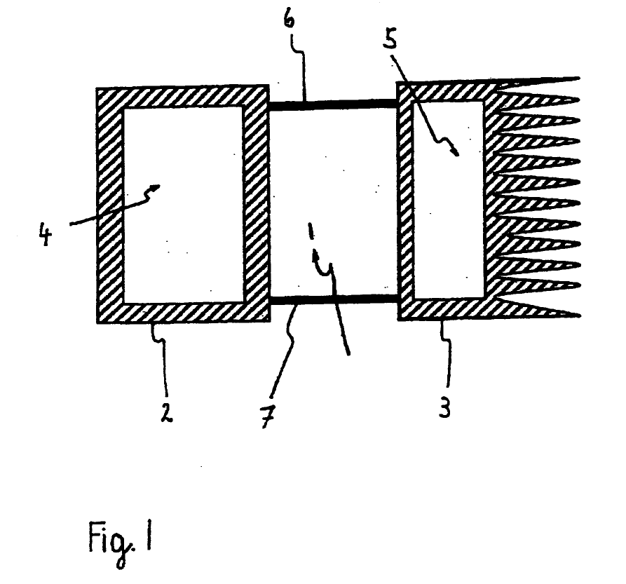

FIG. 1 shows a cross-section of an arrangement according to the invention, of two profile sections connected with one another by means of an insulating chamber.

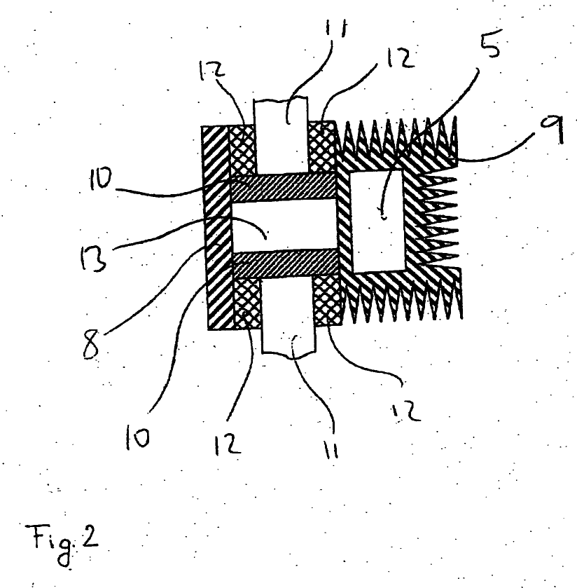

FIG. 2 shows a cross-section of an arrangement according to the invention, in the case of post and bar construction.

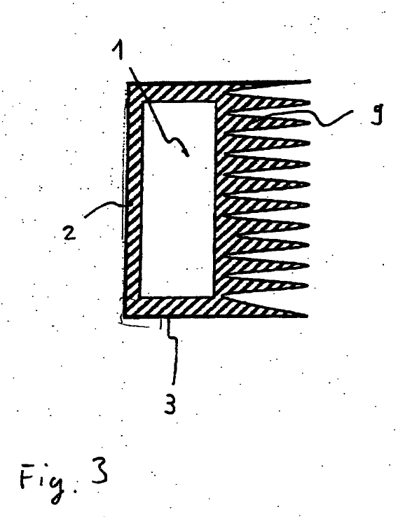

FIG. 3 shows a cross-section of a particularly simple arrangement of two profile sections, connected with one another by means of an insulating chamber.

A cross-section of an arrangement according to the invention of two profile sections 2, 3 that are connected with one another by means of insulating chamber 1 is depicted in FIG. 1. The first profile section 2 is arranged diametrically to the second profile section 3, such that the profile sections 2, 3 exhibit a substantially rectangular cross-section. The profile sections 2, 3 enclose a hollow space, 4, 5, in each case. It is evident that the profile sections 2, 3, can also exhibit any other arbitrary cross-section. Beyond that, the profile sections 2, 3 of the embodiment depicted in FIG. 1 are made of aluminum, though other materials, such as plastic, steel, wood, etc., can be used as well.

On the sides of the profile sections 2, 3 that are oriented toward insulating chamber 1, two connecting crosspieces 6, 7 are arranged, which connect the profile sections 2, 3 with one another and with the sides of profile sections, 2, 3 that are oriented toward the insulating chamber 1, demarcating, or rather constituting, the insulating chamber 1. The connecting crosspieces 6, 7 in the depicted embodiment, are made of plastic, though here, too, other materials can be used. It is advantageous, however, if the connecting crosspieces 6, 7, exhibit a lesser thermal conductivity relative to the profile sections 2, 3.

The surface of the side of the second profile section 3, which is turned away from insulating chamber 1, is enlarged compared to the side that is turned toward insulating chamber 1, in order to render a facilitated thermal transfer from the surroundings to the side of profile section 3 that is turned away from the insulating chamber. In the embodiment depicted in FIG. 1, the enlargement of the side of profile section 3 that is turned away from the insulating chamber is achieved by means of embodying the side in question in the form of ribs, similar to a wave having a multitude of wave peaks and wave valleys, so that, substantially, a cooling rib cross-section results, which functions, in this instance, as a heating rib.

The first profile section 2 abuts an outer zone that is not depicted in FIG. 1; the second profile section 3 abuts an inner zone that is likewise, not depicted. If, for example, the outer zone exhibits a lower temperature level than the inner zone, the temperature of the first profile section 2 of insulating chamber 1 and the second profile section 3 assimilates to the point that a stable temperature profile section comes to prevail across the cross-section of the entire arrangement. In the process, the individual thermal transfers from surroundings/profile section or profile section/insulating chamber and vice versa are determinant for the temperature profile section that is in the process of self-adjustment. Due to the rib-shaped embodiment of the surface of the side of the second profile section 3 that is turned away from insulating chamber 1, the side with the enlarged surface undergoes such thermal penetration that a slight difference in temperature, in the ideal case, no difference in temperature, is present between the second profile section 3 and the abutting zone.

FIG. 2 shows a cross-section of an arrangement according to the invention, in the case of a post and bar construction. What is substantially a covering strip (8) may be discerned here on the left side, and a post (9) on the right side. In this case, the covering strip (8) substantially corresponds to the outer profile section (2) of the embodiment according to FIG. 1 and the post (9) substantially corresponds to the inner profile section (3) of the embodiment according to FIG. 1.

The distance between the covering strip (8) and the post (9) is assured by spacing elements, according to FIG. 2. In the embodiment represented in FIG. 2, the covering strip (8) and the post (9) serve to fix a glass pane or a panel (11). Seals or dampers (12) are provided between the covering strip (8) or the post (9) and the glass pane or panels (11). Post (9) exhibits a hollow space (5), as does the profile section (3) of the embodiment according to FIG. 2. Beyond that, post (9) is, as may be derived from FIG. 2, equipped on all external sides with a cooling rib or heating rib profile section in order to facilitate the thermal transfer from the environment that abuts the post (9) to the post (9). In the embodiment represented in FIG. 2, the post (9), as well as the covering strip (8), are constituted of aluminum. The sides of the covering strip (8) and the post (9), which lie opposite one another, demarcate, together with the distance elements (10), an insulating space (13), which corresponds, substantially, to the insulating chamber (1) of the embodiment according to FIG. 1.

In the case of the embodiment variant depicted in FIG. 3, what is at issue is a hollow profile, such as can be used, for example, in the embodiment according to FIG. 1. The hollow profile, in turn, comprises several sections, of which at least one is provided with an enlarged surface in order to be able to assure an improved thermal transfer. The arrangement depicted here can be used in exemplary fashion as a carrier for the purpose of fixing panels or panes [of glass] to the lateral sections 3.

Although the present invention were [sic—was] completely described above, making reference to a currently preferred embodiment, the expert should recognize that various opportunities for change are possible within the context of the enclosed claims, without deviating from the concept according to the invention and the protection claimed. In particular, the expert should recognize that the surface [of] the side that is turned away from the insulating chamber can exhibit various geometric shapes.

1. An arrangement of at least two profile sections (2, 3, 8, 9), connected with one another by means of an insulating chamber (1, 13), characterized in that at least the surface of the side of at least one profile section (3, 9) that is turned away from the insulating chamber (1, 13) is enlarged compared to the surface of the side that is turned toward the insulating chamber (1, 13), in order to render a facilitated thermal transfer between the surroundings and the side of the profile section (3, 9) that is turned away from the insulating chamber (1, 13) possible.

2. An arrangement according to claim 1, characterized in that the enlarged surface of the side that is turned away from the insulating chamber (1, 13) is embodied in the form of ribs.

3. An arrangement according to claim 2, characterized in that substantially at least one entire side is embodied in the form of ribs.

4. An arrangement according to one of the claims 1 through 3, characterized in that the profile sections (2, 3, 8, 9) constitute a hollow profile.

5. An arrangement according to one of the claims 1 through 4, characterized in that
at least two connecting crosspieces (6, 7, 10) and/or sealing elements (12) in the case of coupled elements, are provided between two profile sections (2, 3), which constitute, with profile sections (2, 3), the insulating chamber (1, 13).

6. An arrangement according to one of the claims 1 through 5, characterized in that the connecting crosspieces (6, 7, 10) are embodied of plastic and the profile sections (2, 3, 8, 9) are embodied of aluminum.
